(19) United States
(12) Patent Application Publication
(10) Pub. No.: US 2020/0261839 A1
(43) Pub. Date: Aug. 20, 2020

(54) FILTER ELEMENT WITH HONEYCOMB BODY FOR AIR CLEANING

(71) Applicant: Carl Freudenberg KG, Weinheim (DE)

(72) Inventors: Edith Kuehl, Darmstadt (DE); Rene Engelke, Heidelberg (DE); Thomas Caesar, Weinheim (DE)

(21) Appl. No.: 16/741,768

(22) Filed: Jan. 14, 2020

(30) Foreign Application Priority Data
Feb. 14, 2019 (EP) 19 157 098.5

(51) Int. Cl. B01D 46/24; B01D 46/00; B01D 46/42; B01D 39/20

(52) U.S. Cl. CPC B01D 46/2459; B01D 46/001; B01D 46/2466; B01D 46/4209; B01D 39/2062; B01D 46/0019

(57) ABSTRACT

A filter element for adsorbing harmful gases from a fluid flow includes: a frame and a plurality of filter bodies arranged at a distance next to one another in the frame. A respective filter body has a plurality of openings. A respective filter body is connected to at least one other of the filter bodies via a respective contact element configured for electrical dissipation. The filter bodies are arranged in matrix form, the filter bodies are formed as honeycomb bodies, and/or the filter bodies comprise activated carbon.

### CROSS-REFERENCE TO RELATED APPLICATION

Priority is claimed to European Patent Application No. EP 19 157 098.5, filed on Feb. 14, 2019, the entire disclosure of which is hereby incorporated by reference herein.

### FIELD

The present invention relates to a filter element and to a filter including a filter element.

### BACKGROUND

From WO 2010/049 052 A1, a filter element is known which is designed as what is known as a combination filter. Such a filter element filters particles and adsorbs gases. Filter elements of this type can be used to keep passenger compartments largely free of harmful substances. Against this background, from DE 101 04 882 B4 a shaped activated carbon body is known which has a honeycomb structure. The shaped activated carbon body is produced by extrusion of a mixture of activated carbon and further substances and serves as an adsorption filter. An objective of such activated carbon filters is to filter out harmful gases from an air flow.

A further filter element which has a shaped activated carbon body with a honeycomb structure is known from DE 101 50 062 B4. EP 2 946 827 A1 discloses another shaped activated carbon body with channels. EP 0 393 729 A2 describes a filter for the purification of exhaust gas from an internal combustion engine. The filter has a plurality of honeycomb-shaped cells made of a porous and electrically conductive material. The respective cells are isolated from each other. A respective cell may be charged with current to heat the filter and affect the filtration performance.

A potential drawback of the filters known from the prior art is that electrical charge accumulates and may lead to undesired spark discharge. This represents a safety risk especially in explosive environments such as, for example, in plants which are used in the oil and gas industry.

### SUMMARY

In an embodiment, the present invention provides a filter element for adsorbing harmful gases from a fluid flow. The filter element includes a frame and a plurality of filter bodies arranged at a distance next to one another in the frame. A respective filter body has a plurality of openings. A respective filter body is connected to at least one other of the filter bodies via a respective contact element configured for electrical dissipation.

### BRIEF DESCRIPTION OF THE DRAWINGS

Embodiments of the present invention will be described in even greater detail below based on the exemplary figures. The present invention is not limited to the exemplary embodiments. All features described and/or illustrated herein can be used alone or combined in different combinations in embodiments of the present invention. The features and advantages of various embodiments of the present invention will become apparent by reading the following detailed description with reference to the attached drawings which illustrate the following:

FIG. 1a shows a first embodiment of a filter element.

FIG. 1b shows a cutout from a plan view of the filter element from FIG. 1a, according to an embodiment.

FIG. 2a shows a second embodiment of a filter element.

FIG. 2b shows a cutout from a plan view of the filter element from FIG. 2a, according to an embodiment.

FIG. 3 shows a third embodiment of a filter element.

FIG. 4 shows a fourth embodiment of a filter element.

FIG. 5 shows a fifth embodiment of a filter element.

FIG. 6 shows a detailed view of a filter body, according to an embodiment.

### DETAILED DESCRIPTION

In an embodiment, the present invention provides a filter element that can adsorb harmful gases and can also be used in explosive environments. Specifically, the filter element can be for adsorbing harmful gases from a fluid flow. The filter element can include a frame and a plurality of filter bodies arranged at a distance next to one another in the frame. Each respective filter body can have a plurality of openings. Each respective filter body can be connected to at least one other of the filter bodies via a respective contact element capable of electrical dissipation.

A filter element according to an embodiment of the invention serves to adsorb harmful gases from a fluid flow, in particular an air flow, and has a frame and a plurality of filter bodies arranged next to one another with a clearance in the frame. A respective filter body thereby has a plurality of flow-through openings. The arrangement of the openings in the filter body can be honeycomb-shaped, so that in this instance it is also possible to speak of a honeycomb body.

According to an embodiment, the openings are thereby designed as channels which pass through the honeycomb body. Air to be filtered can thus flow through the channels without a substantial pressure loss occurring between the inflow side and the outflow side of the filter body.

Advantageously, a respective filter body can be connected to at least one other of the filter bodies via a respective contact element capable of electrical dissipation, and electrical charges are dissipated. A respective filter body can thus also be connected to several, in particular all, of its adjacent filter bodies via a respective contact element that is capable of electrical dissipation. According to an embodiment of the invention, the contact element is thereby made of a material which is capable of electrical dissipation. Thus, good conductivity does not have to be present as in the case of metals; rather, a rather poor conductivity is sufficient, as can be achieved with a plurality of plastics and adhesives.

An advantage of such a filter element is that the dissipation capability is produced not only within a respective filter body but also between the respective filter bodies. As a result of the dissipative connection of the filter bodies with one another, charges occurring in the filter body can be discharged and do not accumulate. By preventing an accumulation of charge, the formation of sparks in the filter element can be avoided.

In an advantageous and therefore preferred embodiment of the filter element, the filter bodies are arranged in matrix form, i.e. in a regular grid structure having rows and columns. Due to the regular grid structure, the filter bodies can be tightly packed and the contact elements that are capable of electrical dissipation can be easily inserted. In an alternative embodiment, the filter bodies are arranged in a composite with an irregular arrangement.

It is advantageous if the filter bodies consist at least partially of activated carbon. An effective adsorption of harmful gases can be achieved via the use of activated carbon.

The filter bodies could advantageously be produced from activated carbon or include activated carbon. Activated carbon can be extruded into a honeycomb body in the form of a paste or as part of a paste. Activated carbon is therefore regarded as an advantageous material. The proportion of activated carbon in the honeycomb body can be between 30% and 80% by weight. In such an embodiment, the honeycomb body has a sufficient amount of activated carbon and is nevertheless mechanically stable.

The honeycomb bodies could be provided with an impregnation. By providing an impregnation adapted to the field of use of the filter element, the adsorption performance can be further improved.

An advantageous honeycomb body includes at least 55% activated carbon by weight. Furthermore, the honeycomb filter can include attendant substances. Advantageous attendant substances are, for example, glassy carbon and/or aluminosilicate. The cell density of the honeycomb body, i.e. the number of channels per unit area, is preferably between 10 and 120 cells/cm², particularly preferably between 30 and 95 cells/cm² according to an embodiment.

The wall thickness of the channel walls can be between 150 micrometers and 450 micrometers. A honeycomb body with a very high number of channels is thereby achieved.

Advantageously, the number of channels in the honeycomb body can be between 30 and 100 channels per square centimeter. This channel density has proven to be particularly advantageous in order to ensure a small pressure loss with high adsorption dynamics.

The contact element that is capable of electrical dissipation can have various designs. In an embodiment, the contact element is designed as an electrically conductive lacquer. The lacquer can be a conductive lacquer which has fractions of graphite, silver, or copper. In an embodiment, the contact element capable of electrical dissipation can be designed as an adhesive, for example as a conductive adhesive which contains fillers such as graphite, silver, copper, for example. The lacquer or the adhesive can simply be applied by spraying, printing, or dropping.

In an embodiment, the contact element is designed as a metal wire or as a metal clip, in particular of copper, silver, or aluminum. The metal wires or metal clips can be connected to the filter bodies by gluing, welding, or plugging in or on.

In an embodiment, an electrically conductive strip, in particular an adhesive strip, can be used as the contact element. In this instance, the strip can be configured as a metal strip, for example of copper, silver, or aluminum, or at least have these constituents as a layer. A metal adhesive strip can be glued onto the filter bodies so that these are quickly connected to one another via the metal adhesive strip.

In an embodiment, the contact element is designed as an electrically conductive plastic matrix, wherein the plastic matrix has recesses for accommodating the filter bodies. This takes place in such a way that the accommodated filter bodies contact the plastic matrix. The plastic matrix may be made of conductive foam, for example electrically conductive polyurethane foam.

In an advantageous embodiment of the filter element according to the invention, at least one of the filter bodies is connected to the frame via a connecting element that is capable of electrical dissipation. Charges can thus be dissipated outward and, for example, be transferred from the filter element to a grounded filter receptacle. It is advantageous if the connecting element is designed as a metal spring, for example made of stainless steel, silver, or copper. The frame can also be designed in particular as a metal frame, made for example of stainless steel or copper. Alternatively, the connecting element can be designed like the contact elements described above.

A filter element as described above can advantageously be used in a filter in an explosive environment, for example in fluid tanks or generally in the oil and gas industry. In the explosive atmospheres present there, it is particularly important that no charges accumulate which could lead to a formation of sparks, and thus to ignition and consequently explosion.

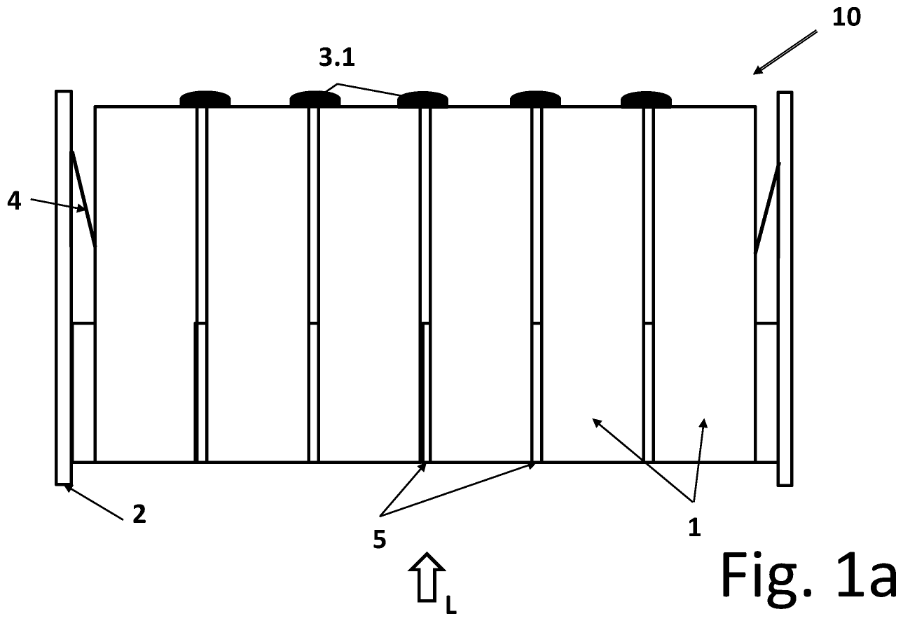

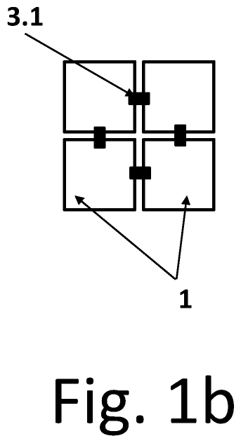

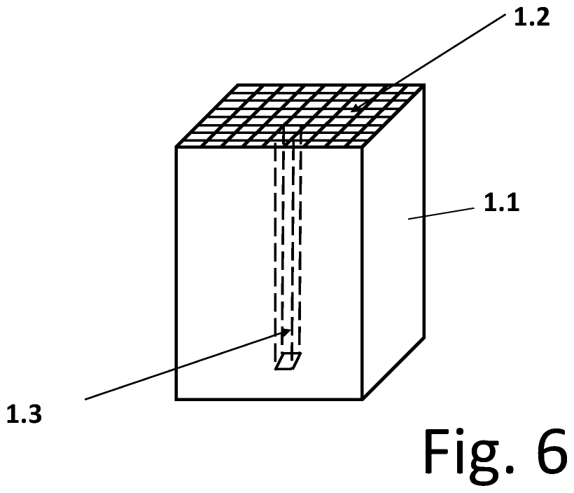

FIG. 1a shows a first embodiment variant of a filter element 10 according to an embodiment of the invention. The filter element 10 has a frame 2 in which a plurality of filter bodies 1 are arranged. The filter bodies 1 can respectively have a structure as it is drawn in FIG. 6: The filter body 1 is thereby executed as a honeycomb body 1.1 which has a plurality of adjacent openings 1.2. A respective opening 1.2 represents the end of a channel 1.3 that is open on both sides. The channels 1.3 are separated from one another by partitions. As in the example from FIG. 6, a respective opening 1.2 can have a square base area. Alternatively, rectangular or hexagonal openings which are reminiscent of honeycombs are also conceivable, for example.

The filter bodies 1 are connected to one another by an adhesive 5 so that they are stably accommodated in the frame 2. However, the adhesive 5 is not capable of electrical dissipation in an embodiment. Thus, a lacquer 3.1 that is capable of electrical dissipation is provided as a dissipative contact element 3, which respectively connects adjacent filter bodies 1 to one another.

A cutout of a plan view of the filter element 10, according to an embodiment, is shown in FIG. 1b. If a charge is formed in a filter body 1, it can be dissipated to the adjacent filter bodies 1 via the contact element 3, i.e. here the lacquer 3.1. At least one of the outlying filter bodies 1 is connected to the frame 2 via a connecting element 4 which is likewise capable of electrical dissipation. An electrical charge can thus be dissipated via the frame 2.

The filter element 10 serves for adsorbing harmful gases from a fluid flow L, which is indicated by an arrow. The fluid flow L can flow through the filter bodies 1, more precisely the channels 1.3, and thereby undergoes a cleaning process.

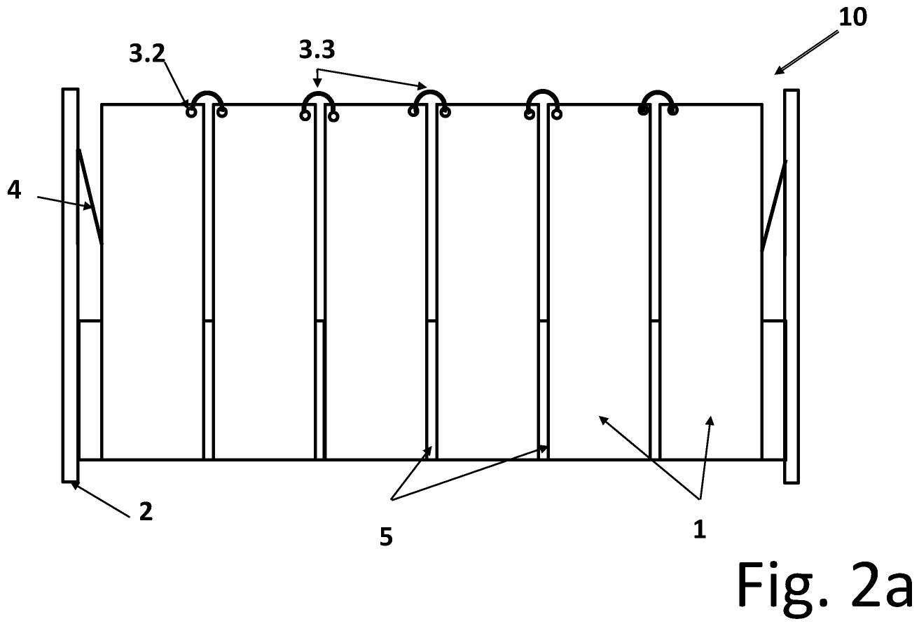

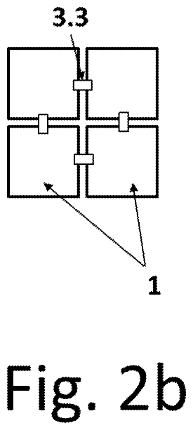

FIG. 2a shows an alternative embodiment of a filter element 10. The filter element 10 thereby has the same structure as the filter element 10 from FIG. 1a. Only the contact elements 3 have been designed differently: Metal wires or metal clips 3.3 which are respectively connected to the filter bodies 1 with a conductive adhesive point 3.2 are used as contact elements 3.

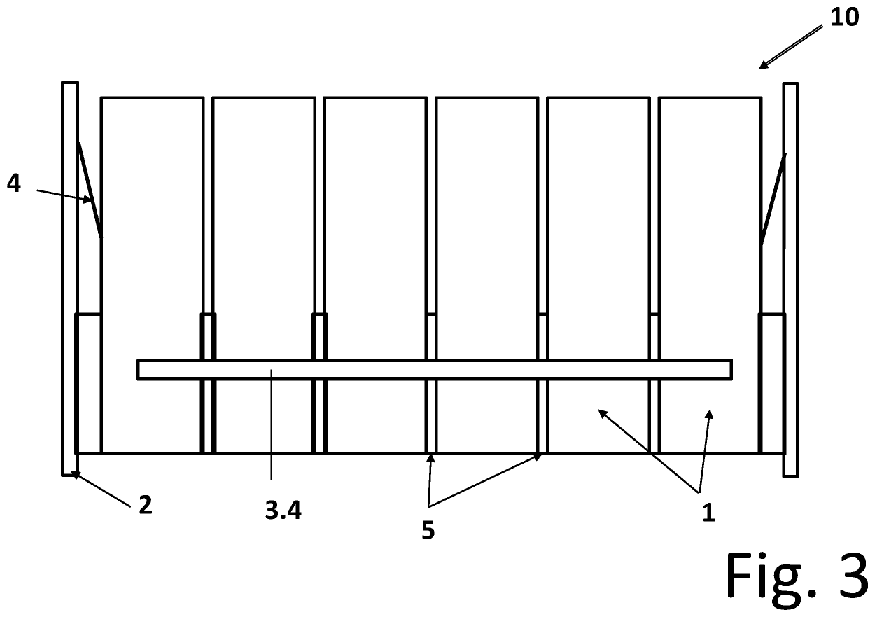

In the alternative embodiment variant of a filter element 10, a conductive strip 3.4 is used as a contact element 3 according to the illustration of FIG. 3. The conductive strip 3.4 connects the filter bodies 1 to one another. In an alternative embodiment which is not shown, the conductive strip 3.4 can connect not only the filter bodies 1 to one another but also the filter bodies 1 to the frame 2. However, here a metal spring 4 is used as connecting elements 4 between the frame 2 and the filter bodies 1.

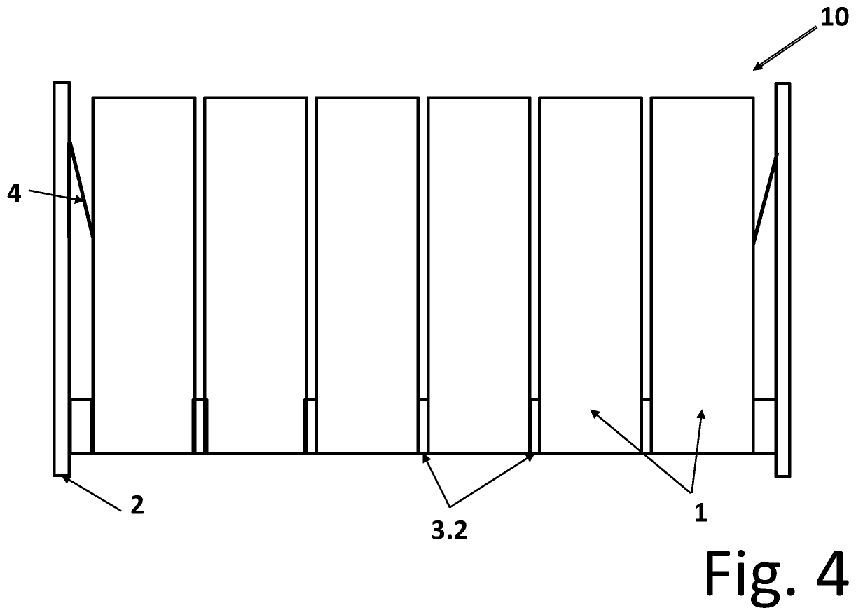

In the embodiment of the filter element 10 shown in FIG. 4, a conductive adhesive 3.2 is used for bonding the filter elements 1 in the frame 2. The conductive adhesive 3.2 thus assumes two tasks: On the one hand, it guarantees a stable positioning of the filter bodies in the frame 2 and also a dissipation of electrical charges between the filter bodies 1. In an embodiment where the filter bodies 1 are glued directly into the frame 2 by means of the conductive adhesive 3.2, the additional connecting element 4 can be absent. Electrical charge can drain directly from the respective outer filter bodies 1 to the frame 2 via the conductive adhesive 3.2.

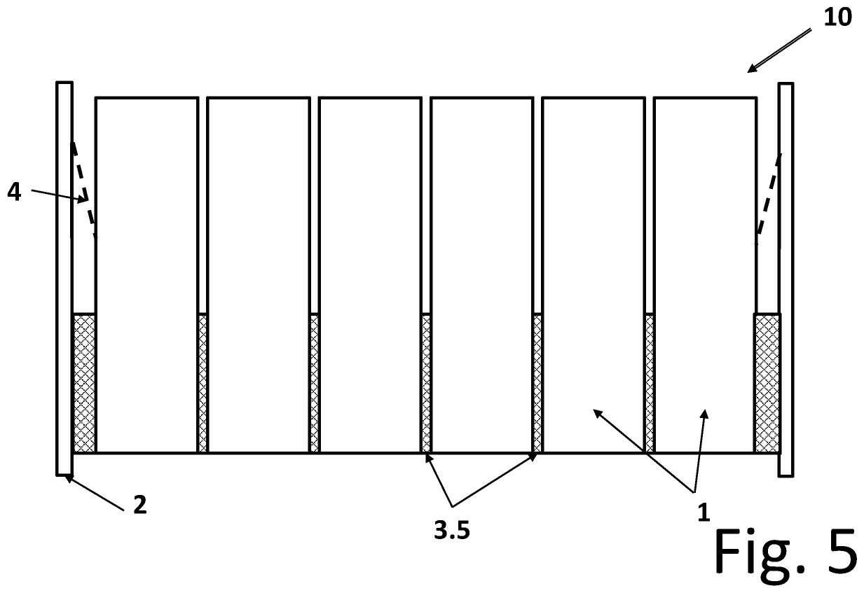

In the embodiment of the filter element 10 from FIG. 5, the connecting element 4 can be absent and is therefore shown in broken lines. In this embodiment, the filter bodies 1 were inserted into a foamed plastic matrix 3.5, wherein the plastic matrix consists of a foam that is capable of electrical dissipation. Charges can thus be dissipated from the filter bodies to the frame 2 via the plastic matrix 3.5.

Referring to the FIGS., an embodiment provides a filter element 10 for adsorbing harmful gases from a fluid flow L, having a frame 2 and a plurality of filter bodies 1 arranged next to one another at a distance in the frame 2, wherein a respective filter body 1 has a plurality of openings 1.2. According to an embodiment, a respective filter body 1 is connected to at least one other of the filter bodies 1 via a respective contact element 3 that is capable of electrical dissipation, and electrical charges are dissipated. A filter for use in an explosive environment, can include filter element 10.

While embodiments of the invention have been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

1 Filter body
1.1 Honeycomb body
1.2 Opening
1.2 Channel
2 Frame
3 Contact element
3.1 Lacquer
3.2 Conductive adhesive
3.3 Metal wire or metal clip
3.4 Conductive strip
3.5 Plastic matrix (foamed)
4 Connecting element
5 Adhesive
10 Filter element
L Air flow

What is claimed is:

1. A filter element for adsorbing harmful gases from a fluid flow, the filter element comprising:
a frame; and
a plurality of filter bodies arranged at a distance next to one another in the frame, wherein a respective filter body has a plurality of openings,
wherein a respective filter body is connected to at least one other of the filter bodies via a respective contact element configured for electrical dissipation.

2. The filter element according to claim 1, wherein the filter bodies are arranged in matrix form, and/or the filter bodies are formed as honeycomb bodies, and/or the filter bodies comprise activated carbon.

3. The filter element according to claim 1, wherein the contact element is formed as an electrically conductive lacquer or as an electrically conductive adhesive.

4. The filter element according to claim 1, wherein the contact element is provided as a metal wire or as a metal clip.

5. The filter element according to claim 1, wherein the contact element is provided as an electrically conductive strip.

6. The filter element according to claim 1, wherein the contact element is provided as an electrically conductive plastic matrix.

7. The filter element according to claim 1, wherein at least one of the filter bodies is connected to the frame via a connecting element that is capable of electrical dissipation, wherein the connecting element comprises a metal spring and the frame comprises metal.

8. The filter element according to claim 1, wherein a respective filter body is connected to each of its adjacent filter bodies via a respective contact element that is configured for electrical dissipation.

9. A filter for use in an explosive environment, the filter comprising the filter element according to claim 1.
